(19) United States
(12) Patent Application Publication
(10) Pub. No.: US 2021/0012081 A1
(43) Pub. Date: Jan. 14, 2021

(54) ELECTRONIC DEVICE PANEL, PHOTOELECTRIC PROCESSING UNIT, ELECTRONIC DEVICE, AND PROCESSING METHOD FOR ELECTRONIC DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Haoqing GUO, Beijing (CN); Lixiang YI, Beijing (CN); Feng XIAO, Beijing (CN); Kwang Gyun JANG, Beijing (CN)

(21) Appl. No.: 16/918,217

(22) Filed: Jul. 1, 2020

(30) Foreign Application Priority Data
Jul. 9, 2019 (CN) 201910614168.4

(51) Int. Cl. G06K 9/00; G06F 1/16; H04M 1/02; G06F 21/32

(52) U.S. Cl. CPC G06K 9/0004; G06F 21/32; H04M 1/0266; G06F 1/1637

(57) ABSTRACT

An electronic device panel, a photoelectric processing unit, an electronic device and a processing method for an electronic device are disclosed. The electronic device panel includes a photoelectric sensing region and a photoelectric processing unit. The photoelectric processing unit includes an optical sensing device and a signal processing device. The optical sensing device is in the photoelectric sensing region, and is configured to sense the photoelectric sensing region, so as to obtain a texture image data signal, and sense ambient light in the photoelectric sensing region, so as to obtain an ambient light detection electrical signal. The signal processing device is configured to process the texture image data signal and the ambient light detection electrical signal.

### CROSS REFERENCE TO RELATED APPLICATIONS

This application claims the priority of Chinese Patent Application No. 201910614168.4, filed on Jul. 9, 2019. For all the purpose under the U.S. law, the entire disclosure of the aforementioned application is incorporated herein by reference as part of the disclosure of this application.

### TECHNICAL FIELD

Embodiments of the present disclosure relate to an electronic device panel, a photoelectric processing unit, an electronic device, and a processing method for an electronic device.

### BACKGROUND

As texture identification technologies (e.g., fingerprint identification or palm-print identification) are maturing, texture identification, especially the fingerprint identification, has become an important means for identity authentication of electronic devices, mobile terminals, etc. With the development of full screen technologies, screen textures have gradually attracted people's attention. In the case where a texture identification module is transferred to a back side of a display screen, a screen texture identification operation and the full screen display can be realized simultaneously. At present, the optical fingerprint is a mainstream method of the screen texture.

### SUMMARY

At least one embodiment of the present disclosure provides an electronic device panel which comprises a photoelectric sensing region and a photoelectric processing unit. The photoelectric processing unit comprises an optical sensing device and a signal processing device. The optical sensing device is in the photoelectric sensing region, and is configured to sense the photoelectric sensing region, so as to obtain a texture image data signal, and sense ambient light in the photoelectric sensing region, so as to obtain an ambient light detection electrical signal. The signal processing device is configured to process the texture image data signal and the ambient light detection electrical signal.

For example, in the electronic device panel provided by at least one embodiment of the present disclosure, the optical sensing device comprises an imaging array and a photoelectric sensor. The imaging array is configured to sense the photoelectric sensing region to obtain the texture image data signal, and the photoelectric sensor is configured to sense the ambient light in the photoelectric sensing region to obtain the ambient light detection electrical signal.

For example, in the electronic device panel provided by at least one embodiment of the present disclosure, the imaging array and the photoelectric sensor are on a same substrate, the imaging array comprises a plurality of imaging array units, and the photoelectric sensor is between adjacent imaging array units within the imaging array or at an edge of the imaging array.

For example, in the electronic device panel provided by at least one embodiment of the present disclosure, the imaging array and the photoelectric sensor are on different substrates, and the different substrates are stacked one on another.

For example, in the electronic device panel provided by at least one embodiment of the present disclosure, the photoelectric sensing region is a fingerprint identification region, the texture image data signal is a fingerprint image data signal, and the optical sensing device is configured to sense the photoelectric sensing region to obtain the fingerprint image data signal.

For example, in the electronic device panel provided by at least one embodiment of the present disclosure, the signal processing device comprises a first processing circuit that is used for the texture image data signal and a second processing circuit that is used for the ambient light detection electrical signal. The first processing circuit and the second processing circuit are integrated on a same circuit board or integrated in a same chip.

For example, in the electronic device panel provided by at least one embodiment of the present disclosure, the optical sensing device and the signal processing device are on a same circuit board, and the optical sensing device is electrically connected to the signal processing device.

For example, the electronic device panel provided by at least one embodiment of the present disclosure further comprises a controller. The controller is configured to: control the optical sensing device to detect the ambient light in the photoelectric sensing region; determine whether the ambient light is weakened according to a processing result of the ambient light detection electrical signal obtained by the signal processing device; determine whether a condition of texture image detection is satisfied in the case where the ambient light is weakened; and control the optical sensing device to perform the texture image detection on the photoelectric sensing region in the case where the condition of the texture image detection is satisfied.

For example, the electronic device panel provided by at least one embodiment of the present disclosure further comprises a light source array. The light source array comprises a plurality of light source units. The plurality of light source units are at least partially in the photoelectric sensing region and are configured to emit light according to a light emission signal, so as to provide illumination light for texture image detection.

For example, the electronic device panel provided by at least one embodiment of the present disclosure further comprises a controller. The controller is configured to increase luminous brightness of the light source array in the photoelectric sensing region in response to a processing result of the photoelectric processing unit.

For example, in the electronic device panel provided by at least one embodiment of the present disclosure, the controller is further configured to light at least part of the light source units in the photoelectric sensing region or light a sub-array that is formed by at least part of the light source units, so as to provide the illumination light for the texture image detection.

For example, in the electronic device panel provided by at least one embodiment of the present disclosure, the electronic device panel is a display panel that comprises a display region. The display region comprises a display pixel array, the display pixel array comprises a plurality of display pixel units, and each of the display pixel units comprises a display sub-pixel unit. The light source array comprises at least part of the display pixel array, each of the plurality of light source units comprises one or more display pixel units or one or more display sub-pixel units, and the photoelectric sensing region is within the display region.

At least one embodiment of the present disclosure also provides a photoelectric processing unit, which comprises an optical sensing device and a signal processing device. The optical sensing device is in a photoelectric sensing region, and is configured to sense the photoelectric sensing region, so as to obtain a texture image data signal, and sense ambient light in the photoelectric sensing region, so as to obtain an ambient light detection electrical signal. The signal processing device is configured to process the texture image data signal and the ambient light detection electrical signal.

For example, in the photoelectric processing unit provided by at least one embodiment of the present disclosure, the optical sensing device and the signal processing device are on a same circuit board, and the optical sensing device is electrically connected to the signal processing device.

At least one embodiment of the present disclosure also provides an electronic device. The electronic device comprises the electronic device panel described above or the photoelectric processing unit described above.

At least one embodiment of the present disclosure also provides a processing method for an electronic device. The electronic device comprises a photoelectric sensing region, and the processing method comprises: detecting ambient light in the photoelectric sensing region, so as to obtain an ambient light detection electrical signal; determining whether the ambient light is weakened according to a processing result of the ambient light detection electrical signal; determining whether a condition of texture image detection is satisfied in the case where the ambient light is weakened; and sensing the photoelectric sensing region to obtain a texture image data signal in the case where the condition of the texture image detection is satisfied.

For example, in the processing method for the electronic device provided by at least one embodiment of the present disclosure, the condition of the texture image detection comprises: the ambient light reducing by an amount of light of a predetermined range during a predetermined time.

For example, the processing method for the electronic device provided by at least one embodiment of the present disclosure further comprises: processing the texture image data signal to perform a texture identification operation, and performing a system operation or an application operation that is performed subsequently, in the case where the texture identification operation is successful.

For example, the processing method for the electronic device provided by at least one embodiment of the present disclosure further comprises: increasing luminous brightness of a light source array in the photoelectric sensing region, sensing the photoelectric sensing region again, and performing the texture identification operation again, in the case where the texture identification operation fails.

For example, the processing method for the electronic device provided by at least one embodiment of the present disclosure further comprises: reducing luminous brightness of a light source array in the photoelectric sensing region, and closing an operation that is used for texture identification, after the texture identification operation is successful.

### BRIEF DESCRIPTION OF THE DRAWINGS

In order to more clearly illustrate the technical schemes of the embodiments of the present disclosure, the drawings of the embodiments will be briefly described in the following. It is obvious that the described drawings below are only related to some embodiments of the disclosure and are not limitative to the present disclosure.

FIG. 1A is a schematic diagram of an electronic device panel provided by some embodiments of the present disclosure;

FIG. 1B is an exemplary schematic diagram of a display panel having a fingerprint identification function provided by some embodiments of the present disclosure;

FIG. 2 is a schematic diagram of an optical sensing device in an electronic device panel provided by some embodiments of the present disclosure;

FIG. 3A illustrates an arrangement diagram of an imaging array and a photoelectric sensor in an electronic device panel provided by some embodiments of the present disclosure;

FIG. 3B illustrates another arrangement diagram of an imaging array and a photoelectric sensor in an electronic device panel provided by some embodiments of the present disclosure;

FIG. 3C illustrates still another arrangement diagram of an imaging array and a photoelectric sensor in an electronic device panel provided by some embodiments of the present disclosure;

FIG. 4 is a schematic diagram of a signal processing device in an electronic device panel provided by some embodiments of the present disclosure;

FIG. 5A is a schematic diagram of another electronic device panel provided by some embodiments of the present disclosure;

FIG. 5B is a schematic cross sectional view of another display panel having a fingerprint identification function provided by some embodiments of the present disclosure;

FIG. 6 is a flowchart of a processing method for an electronic device provided by some embodiments of the present disclosure;

FIG. 7 is an exemplary flowchart of a processing method for an electronic device, which is applied to texture identification, provided by some embodiments of the present disclosure; and

FIG. 8 is an exemplary flowchart of a processing method for an electronic device that includes a display panel, which is applied to fingerprint identification for unlocking, provided by some embodiments of the present disclosure.

### DETAILED DESCRIPTION

In order to make the objects, technical schemes and advantages of the embodiments of the present disclosure more clear, the technical schemes of the embodiments of the present disclosure will be described in a clear and full way in connection with the drawings. Obviously, the described embodiments are some embodiments of the present disclosure, not all embodiments. Based on the described embodiments of the present disclosure, all other embodiments obtained by those of ordinary skill in the art without the use of inventive faculty are within the scope of the present disclosure.

Unless otherwise defined, all the technical and scientific terms used herein have the same meanings as commonly understood by those of ordinary skill in the art to which the present disclosure belongs. The terms “first,” “second,” etc., which are used in the present disclosure, are not intended to indicate any sequence, amount or importance, but used to distinguish various components. Similarly, the terms, such as “a/an,” “the,” “one,” etc., are not intended to indicate the limitation on amounts, but used to denote the presence of at least one. The terms, such as “comprise/comprising,” “include/including,” etc., are intended to specify that the elements or the objects stated before these terms encompass the elements or the objects and equivalents thereof listed after these terms, but not preclude other elements or objects. The terms, such as “connect/connecting/connected,” “couple/coupling/coupled” etc., are not limited to a physical connection or mechanical connection, but may include an electrical connection/coupling, directly or indirectly. The terms, “on,” “under,” “left,” “right,” etc., are only used to indicate relative position relationship, and when the position of the object which is described is changed, the relative position relationship may be changed accordingly.

At present, wake-up methods for screen textures of electronic devices are very limited, and the wake-up methods mainly include touch screen wake-up, gravity inducted wake-up, etc. However, these wake-up methods tend to cause a false touch, which results in the false lighting of a screen, thereby wasting the power of the electronic device, shortening the service life of the screen, and affecting the user's experience. Therefore, a new wake-up method for the texture image detection is required.

Because most of the screen texture detections belong to optical sensing systems, and the ambient light sensor (ALS), which is usually used to sense ambient light conditions for adjusting the brightness of the screen, also belongs to the optical sensing systems, in some cases, the inventors of the present disclosure consider integrating a screen texture detection device with the ambient light sensor, and in some other cases, the inventors of the present disclosure further consider integrating a processing circuit that is used for the screen texture detection device with a processing circuit that is used for the ambient light sensor, thereby improving the integration level of the device, reducing the cost, etc.

At least one embodiment of the present disclosure provides an electronic device panel, which includes a photoelectric sensing region and a photoelectric processing unit. The photoelectric processing unit includes an optical sensing device and a signal processing device. The optical sensing device is in the photoelectric sensing region, and is configured to sense the photoelectric sensing region, so as to obtain a texture image data signal, and sense ambient light in the photoelectric sensing region, so as to obtain an ambient light detection electrical signal. The signal processing device is configured to process the texture image data signal and the ambient light detection electrical signal.

At least one embodiment of the present disclosure also provides a photoelectric processing unit, which includes an optical sensing device and a signal processing device. The optical sensing device is in a photoelectric sensing region, and is configured to sense the photoelectric sensing region, so as to obtain a texture image data signal, and sense ambient light in the photoelectric sensing region, so as to obtain an ambient light detection electrical signal. The signal processing device is configured to process the texture image data signal and the ambient light detection electrical signal.

At least one embodiment of the present disclosure also provides an electronic device, which includes the electronic device panel described above or the photoelectric processing unit described above.

The electronic device panel or the photoelectric processing unit provided by the embodiments of the present disclosure improves the integration level of the electronic device, effectively saves the internal space of the electronic device, and can further provide a new wake-up method for the texture image detection by combining the ambient light detection function with the texture image detection function, which can avoid the false lighting caused by false touch.

At least one embodiment of the present disclosure also provides a processing method for an electronic device. The electronic device includes a photoelectric sensing region, and the processing method includes: detecting ambient light in the photoelectric sensing region, so as to obtain an ambient light detection electrical signal; determining whether the ambient light is weakened according to a processing result of the ambient light detection electrical signal; determining whether a condition of texture image detection is satisfied in the case where the ambient light is weakened; and sensing the photoelectric sensing region to obtain a texture image data signal in the case where the condition of the texture image detection is satisfied.

The processing method provided by the embodiments of the present disclosure described above effectively improves the user's experience of the electronic device, saves the power consumption of the electronic device, and prolongs the service life of the screen.

The embodiments of the present disclosure and examples thereof are described in detail below with reference to the accompanying drawings.

At least one embodiment of the present disclosure provides an electronic device panel, and the electronic device panel is applicable to any electronic device having a display function, such as a smart phone, a tablet computer, a smart door lock, etc. The electronic device panel includes, for example, an organic light-emitting diode (OLED) display panel (e.g., a flexible OLED display panel) or a quantum dot light emitting diode (QLED) display panel, etc.

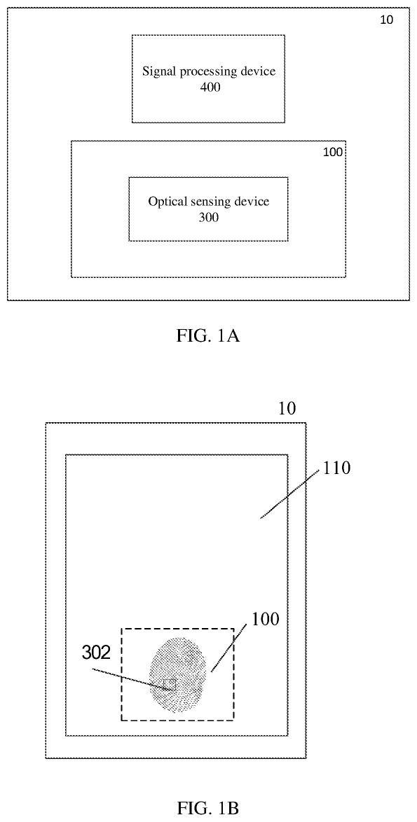

FIG. 1A is a schematic diagram of an electronic device panel 10 provided by some embodiments of the disclosure, and FIG. 1B is an exemplary schematic diagram of a display panel having a fingerprint identification function provided by some embodiments of the present disclosure.

As illustrated in FIG. 1A, the electronic device panel 10 includes a photoelectric sensing region 100 and a photoelectric processing unit. The photoelectric processing unit includes an optical sensing device 300 and a signal processing device 400. The optical sensing device 300 is in the photoelectric sensing region 100, and is configured to sense the photoelectric sensing region 100, so as to obtain a texture image data signal, and sense ambient light in the photoelectric sensing region 100, so as to obtain an ambient light detection electrical signal. The signal processing device 400 is configured to process the texture image data signal and the ambient light detection electrical signal.

In addition, the electronic device panel 10 may also include other structures or functional layers as required. For example, in some embodiments, the electronic device panel 10 may include a touch layer for implementing a touch function, the touch layer may be of various types, such as a capacitive-type touch structure, a resistive-type touch structure, etc., and the capacitive-type touch structure may be a self-capacitive touch structure or a mutual capacitive touch structure. For another example, the electronic device panel 10 may further include a protective layer, and for example, the protective layer is a protective cover plate that is made of transparent materials such as glass, polyimide, etc. For example, in some embodiments, the electronic device panel 10 may further include functional layers such as a polarizer layer, which may be bonded to the panel 10 through an optically clear adhesive (OCA). The embodiments of the present disclosure do not specifically limit other structures of the electronic device panel 10.

Compared with the case where an optical sensing device that is used for sensing texture image data and an optical sensing device that is used for sensing ambient light are arranged in different regions (e.g., arranged in a display region and a peripheral region outside the display region, respectively), the integration level of the electronic device is improved, and the internal space of the electronic device is effectively saved, by arranging the optical sensing device 300, that is used for sensing the texture image data (e.g., a palm print or fingerprint) and used for sensing the ambient light, in one photoelectric sensing region 100. In addition, the integrated arrangement combines the ambient light detection function and the texture image detection function, thereby providing a new wake-up method for texture image detection. The wake-up method can also interact with multi-modes such as screen brightness adjustment, screen protection, identity authentication and the like, thereby effectively improving the use experience of users, saving the power consumption of the electronic device, and prolonging the service life of the screen.

In actual usage, for example, on a mobile terminal (e.g., a smart phone or a tablet computer), the identity authentication is usually performed by using a screen fingerprint, so that, for example, an unlocking operation or a payment operation can be performed. In the following, an electronic device panel having a fingerprint identification function, which is the most common, is described in detail as an example.

In this case, the photoelectric sensing region 100 may be a fingerprint identification region, the texture image data signal may be a fingerprint image data signal, and the optical sensing device 300 may be configured to sense the photoelectric sensing region 100 to obtain the fingerprint image data signal.

As illustrated in FIG. 1B, the electronic device panel 10 of the embodiments of the present disclosure may be implemented as a display panel, and the display panel includes a display region 110. The display region 110 includes a display pixel array that is used for implementing a display function, and the display region 110 further includes the photoelectric sensing region 100 (which is also referred to as a fingerprint identification region herein) denoted by a dotted line frame. The fingerprint identification region overlaps with the display pixel array within this region, so that, in the case where the fingerprint image detection function and the ambient light detection function can be implemented, the implementation of the display function of the display pixel array within this region is not affected. And as described below, the display pixel array within this region can also at least partially serve as a light source of illumination light for fingerprint image detection. The periphery of the display region 110 is a peripheral region, for example, a border region of the electronic device panel 10. The fingerprint identification region 100 is at least part of a predetermined region in the display region 110, and the optical sensing device that is used for sensing texture image data and the optical sensing device 300 that is used for sensing ambient light are arranged at positions corresponding to the region. In the case where the fingerprint identification is required, a user places a finger in the fingerprint identification region 100, and the display region 110 is in a display (or luminous) state at this time. Light is irradiated on a surface of the finger, and the reflected light that is reflected by the surface of the finger is incident on the optical sensing device 300 on a back side of the panel, so that a texture image data signal (i.e., a fingerprint image data signal) is detected by the optical sensing device 300, thereby implementing the fingerprint detection function. In addition, the optical sensing device 300 (e.g., the sensor part in FIG. 1B, e.g., the photoelectric sensor 302 described below) in the fingerprint identification region 100, which is used for sensing ambient light, can also detect the ambient light in real time, thereby adjusting the luminous brightness of the display region 110. Further, in the case where a finger of a user is placed in the fingerprint identification region 100, the optical sensing device 300 can sense the variation of the ambient light caused by the occlusion of the finger of the user. Of course, this variation refers to the variation of the amount of ambient light irradiated on the optical sensing device 300, instead of the variation of ambient light in the whole environment. It should be noted that the size of the display region 110 is generally greater than or equal to the size of the photoelectric sensing region 100 (here, the fingerprint identification region).

Therefore, the above embodiments of the present disclosure improve the integration level of the electronic device, effectively saves the internal space of the electronic device, and also provides a new wake-up method for screen fingerprint detection by arranging the optical sensing device 300 that is used for sensing the fingerprint image data signal and the ambient light detection signal in the fingerprint identification region 100. In addition, the fingerprint wake-up method is combined with the screen brightness adjustment, which can improve the user's experience and save power consumption.

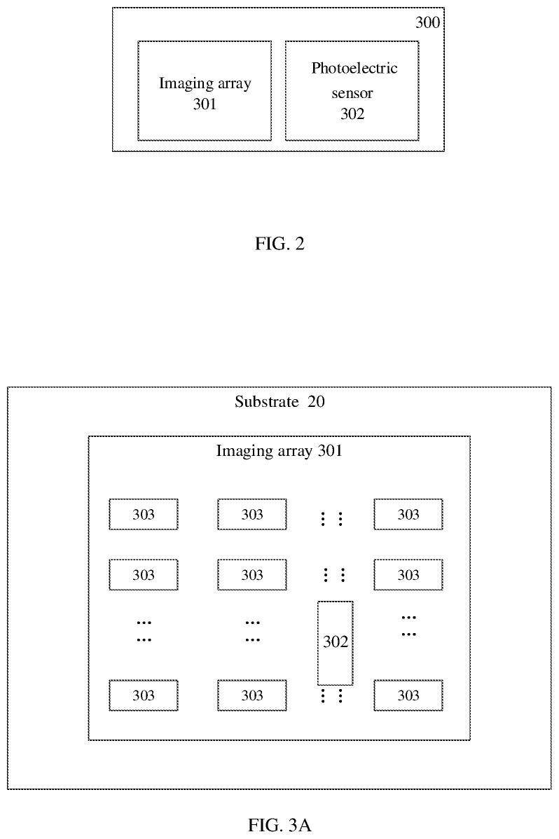

FIG. 2 is a schematic diagram of an optical sensing device 300 in an electronic device panel 10 provided by some embodiments of the present disclosure.

As illustrated in FIG. 2, for example, in some embodiments, the optical sensing device 300 includes an imaging array 301 and a photoelectric sensor 302. The imaging array 301 is configured to sense the photoelectric sensing region 100 to obtain a texture image data signal, and the photoelectric sensor 302 is configured to sense ambient light in the photoelectric sensing region 100 to obtain an ambient light detection electrical signal.

Both the imaging array 301 and the photoelectric sensor 302 belong to optical sensing systems. The photoelectric sensor 302 generates an electrical signal by sensing ambient light conditions, and transmits the electrical signal to a processing circuit, thereby adjusting the screen brightness. For example, in the case where the electronic device panel includes the display region 110 and the display region 110 includes the photoelectric sensing region 100, the screen brightness of the display region can be appropriately raised when the ambient brightness that is detected is relatively high, and the screen brightness can be appropriately lowered when the ambient brightness that is detected is relatively low. Therefore, the photoelectric sensor 302 can be used to adjust the screen brightness for prolonging the working time of the battery to the maximum extent and protecting the eyesight of users. In addition, the imaging array 301 performs texture image detection in response to a certain condition of the texture image detection (e.g., a sudden change of the ambient light, a touch on the photoelectric sensing region 100 by an operator having textures (e.g., a finger or a palm of the operator)).

It should be noted that the operator having textures can be a hand, and in this case, the textures identified by the imaging array 301 are skin textures, such as fingerprints, palm prints, etc. In addition, the operator having textures can also be non-living bodies having certain textures, such as objects having certain textures which are made of materials such as resin and the like, and the embodiments of the present disclosure are not specifically limited thereto.

By arranging the imaging array 301 and the photoelectric sensor 302 in the photoelectric sensing region 100, it is possible to determine whether a certain condition of the texture image detection is satisfied in the case where the photoelectric sensor 302 detects that the ambient light in the photoelectric sensing region 100 is weakened. If so, the imaging array 301 is activated to perform the texture image detection. Therefore, some embodiments of the present disclosure provide a wake-up method for the texture image detection.

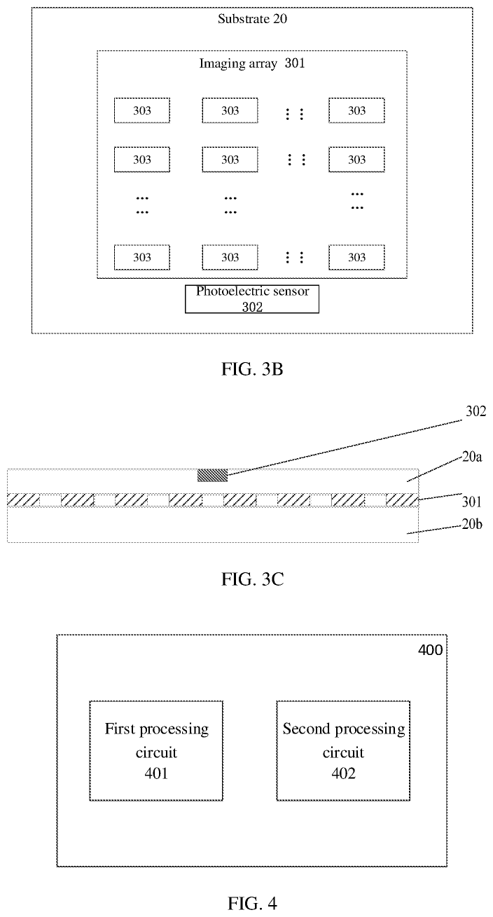

FIG. 3A illustrates an arrangement diagram of an imaging array 301 and a photoelectric sensor 302 in an electronic device panel 10 provided by some embodiments of the present disclosure, FIG. 3B illustrates another arrangement diagram of an imaging array 301 and a photoelectric sensor 302 in an electronic device panel 10 provided by some embodiments of the present disclosure, and FIG. 3C illustrates still another arrangement diagram of an imaging array 301 and a photoelectric sensor 302 in an electronic device panel 10 provided by some embodiments of the present disclosure.

As described above, the optical sensing device 300 that includes the imaging array 301 and the photoelectric sensor 302 is required to be in the photoelectric sensing region 100, but the embodiments of the present disclosure do not limit the specific arrangements of the imaging array 301 and the photoelectric sensor 302 in the photoelectric sensing region 100.

For example, in some embodiments, the imaging array 301 and the photoelectric sensor 302 may be arranged on a same substrate 20, as illustrated in FIG. 3A and FIG. 3B. For example, the substrate 20 may be a silicon substrate, a glass substrate, a ceramic substrate, etc. The imaging array 301 includes a plurality of imaging array units 303, for example, arranged in a matrix. The photoelectric sensor 302 may be between adjacent imaging array units 303 within the imaging array 301. For example, the photoelectric sensor 302 may be in a gap between adjacent imaging array units 303 within the imaging array 301, as illustrated in FIG. 3A. It should be noted that the photoelectric sensor 302 may be arranged in a gap between adjacent imaging array units 303 in a row direction, in a gap between adjacent imaging array units 303 in a column direction, or may be overlapped with the imaging array units 303, and the embodiments of the present disclosure are not limited thereto.

In addition, the photoelectric sensor 302 may also be arranged at an edge of the imaging array 301. For example, the photoelectric sensor 302 is arranged at a lower edge of the imaging array 301 and is close to the imaging array 301, as illustrated in FIG. 3B. It should be noted that the photoelectric sensor 302 may also be arranged at an upper edge, a left edge or a right edge of the imaging array 301, and the embodiments of the present disclosure are not limited thereto.

For example, in at least one example, each of the imaging array units 303 also includes a photoelectric sensing circuit, so that the imaging array 301 and the photoelectric sensor 302 can be simultaneously fabricated on the same substrate 20 by using a same semiconductor fabrication process. The photoelectric sensing circuit of the imaging array unit 303 and the photoelectric sensor 302 may include, for example, a photodiode, a phototransistor, or the like, and may further include a drive circuit (e.g., a transistor, a capacitor, and the like) as needed, so as to implement the functions of signal storage, amplification, output, and the like. For example, the photodiode may be of various types, and for example, the photodiode may be a silicon-based photodiode, a gallium arsenide-based photodiode, and the like, and may also be a PN-type photodiode or a PIN-type photodiode, etc. For example, the imaging array unit 303 may be implemented as a visible light image sensor or an infrared light image sensor, such as a charge coupled device (CCD) type image sensor or a complementary metal oxide semiconductor (CMOS) type image sensor, etc., and the embodiments of the present disclosure do not specifically limit the type of the photoelectric sensor.

For example, in some embodiments, the imaging array 301 and the photoelectric sensor 302 may also be arranged on different substrates, and these different substrates are stacked one on another. Therefore, the imaging array 301 and the photoelectric sensor 302 are respectively formed on different substrates by using different semiconductor fabrication processes. As illustrated in FIG. 3C, the photoelectric sensor 302 is arranged on a first substrate 20a, and the imaging array 301 is arranged on a second substrate 20b, and the first substrate 20a and the second substrate 20b are stacked, that is, an orthographic projection of the first substrate 20a in a direction perpendicular to a surface of the second substrate 20b is within the second substrate 20b. For example, the first substrate 20a is a glass substrate or the like, whereby the light incident from the upper side in the figure can be transmitted. The second substrate 20b may be a silicon substrate, a glass substrate, a ceramic substrate, or the like.

It should be noted that FIGS. 3A to 3C only schematically illustrate examples of the arrangements of the imaging array 301 and the photoelectric sensors 302, but the embodiments of the present disclosure do not limit the number and arrangements of the imaging array units 303 included in the imaging array 301, and do not limit the number and specific positions of the photoelectric sensors 302, as long as the photoelectric sensors 302 are close to the imaging array 301 and within the photoelectric sensing region 100.

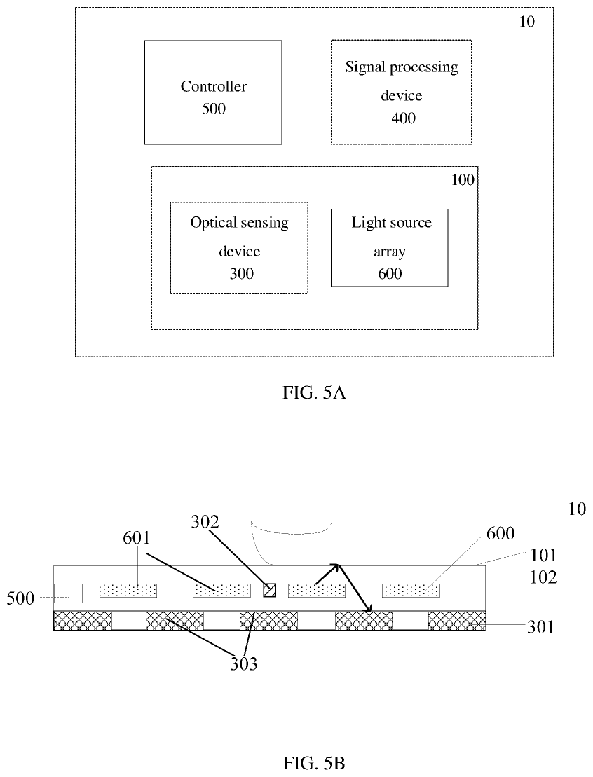

FIG. 4 is a schematic diagram of a signal processing device 400 in an electronic device panel 10 provided by some embodiments of the present disclosure.

As illustrated in FIG. 4, for example, in some embodiments, the signal processing device 400 includes a first processing circuit 401 that is used for a texture image data signal and a second processing circuit 402 that is used for an ambient light detection electrical signal, and the first processing circuit 401 and the second processing circuit 402 are integrated on a same circuit board (e.g., a flexible printed circuit board) or integrated in a same chip, such as an integrated circuit chip. The circuit board is then electrically connected to other circuit boards or is in signal connection with other circuit boards, in the manner of, for example, binding, etc.

The first processing circuit 401 receives the texture image data signal from the imaging array 301, and executes a corresponding algorithm to process the texture image processing signal that is received, for example, to perform a texture identification operation, etc. The second processing circuit 402 receives the ambient light detection electrical signal from the photoelectric sensor 302, and executes a corresponding algorithm that is different from the algorithm described above, so as to process the ambient light detection electrical signal that is received, for example, to perform an ambient light detection operation, etc.

For example, the first processing circuit 401 and the second processing circuit 402 are integrated into a same chip, and the texture identification and the ambient light detection are respectively performed through two algorithms of the chip, so that only one chip is used, and the cost can be saved. Therefore, integrating the first processing circuit 401 and the second processing circuit 402 on the same circuit board (e.g., a flexible printed circuit board) or in the same chip can save space or the usage amount of chips, thereby saving the cost. For example, the first processing circuit 401 and the second processing circuit 402 may be separately or integrally implemented as a data signal processor (DSP), a field programmable gate array (FPGA), or the like. The embodiments of the present disclosure do not limit the implementation of the processing circuit.

FIG. 5A is a schematic diagram of another electronic device panel 10 provided by some embodiments of the present disclosure, and FIG. 5B is a schematic cross sectional view of another electronic device panel 10 that is used for fingerprint identification provided by some embodiments of the present disclosure.

For example, in some embodiments, the optical sensing device 300 and the signal processing device 400 are on a same circuit board (e.g., a flexible printed circuit board), and the optical sensing device 300 is electrically connected to the signal processing device 400, as illustrated in FIG. 5A.

For example, in some embodiments, the electronic device panel 10 further includes a controller 500, as illustrated in FIG. 5A. The controller 500 is in signal connection with the optical sensing device 300 and the signal processing device 400 (for example, communicates through a bus), and can be implemented as a central processing unit (CPU), a data signal processor (DSP), a field programmable gate array (FPGA), etc., and the embodiments of the present disclosure are not limited thereto. The controller 500 is configured to: control the optical sensing device 300 to detect ambient light in the photoelectric sensing region 100; determine whether the ambient light is weakened according to a processing result of the ambient light detection electrical signal obtained by the signal processing device 400; determine whether a condition of texture image detection is satisfied in the case where the ambient light is weakened; and control the optical sensing device 300 to perform the texture image detection on the photoelectric sensing region 100 in the case where the condition of the texture image detection is satisfied. Therefore, the controller 500 can control the implementation of a wake-up method for the texture image detection in the electronic device panel 10, and can also control the optical sensing device that is used for detecting the ambient light to detect the screen brightness in real time, so as to prevent the screen brightness from being too high, thereby prolonging the service life of the screen.

For example, in some embodiments, the electronic device panel 10 further includes a light source array 600, and the light source array 600 is also in signal connection with the controller 500. As illustrated in FIG. 5A, the light source array 600 includes a plurality of light source units 601, and for example, each of the light source units 601 can be individually controlled to emit light or not. For another example, each of the light source units 601 can be implemented by a light emitting diode (e.g., an inorganic light emitting diode, an organic light emitting diode, etc.). The plurality of light source units 601 are at least partially within the photoelectric sensing region 100 and are configured to emit light according to a light emission signal provided by, for example, the controller 500, so as to provide illumination light for the texture image detection. For example, in some embodiments, the controller 500 is configured to increase luminous brightness of one or more light source units 601 of the light source array 600 within the photoelectric sensing region 100, in response to a processing result of the photoelectric processing unit. For still another example, in some embodiments, the controller 500 is configured to light at least part of the light source units 601 in the photoelectric sensing region 100 or light a sub-array that is formed by at least part of the light source units 601, so as to provide the illumination light for the texture image detection. For example, lighting at least part of the light source units 601 in the photoelectric sensing region 100 or lighting the sub-array that is formed by at least part of the light source units 601 includes enpowering at least part of the light source units 601 in the photoelectric sensing region 600 to emit light. For example, the sub-array may be formed by a part of non-adjacent light source units 601. For example, one light source unit is selected every other light source unit in a row direction and in a column direction, so as to form the sub-array. Therefore, the light source array 600 can not only adjust the luminous brightness based on the processing result of the ambient light detection electrical signal, thereby adjusting the luminous brightness of the electronic device and saving power consumption, the light source array 600 can also increase the brightness of the photoelectric sensing region 100 to improve the success rate of texture identification during the process of the texture identification under the control of the controller 500, which is described in detail in the following.

It should be noted that the light source array 600 illustrated in FIG. 5A is entirely included in the photoelectric sensing region 100, and the embodiments of the present disclosure include, but are not limited to this case. For example, in addition to the light source units 601 within the photoelectric sensing region 100, the light source array 600 may also include a plurality of light source units 601 that may be partially outside the photoelectric sensing region 100.

For example, in some embodiments, the electronic device panel 10 may be a display panel that includes the display region 110 (as illustrated in FIG. 1B). In this case, a display pixel array of the display region includes a plurality of display pixel units, each display pixel unit includes a display sub-pixel unit, the display pixel array may function as the light source array 600, and the display pixel unit or the display sub-pixel unit may function as the light source unit 601. That is, the light source array 600 includes at least part of the display pixel array, each light source unit 601 includes one or more display pixel units or one or more display sub-pixel units, and the corresponding photoelectric sensing region 100 is within the display region 110. The display pixel array of the display region 110 can adjust the luminous brightness based on the processing result of the ambient light detection electrical signal, thereby adjusting the luminous brightness of the display panel and saving power consumption. The display pixel array of the display region 110 may also light at least part of the display pixel units or display sub-pixel units within the photoelectric sensing region 100 based on the control of the controller 500, so as to provide illumination light for texture image detection.

It should be noted that the display region 110 in the embodiments of the present disclosure may be greater than or equal to the photoelectric sensing region 100. For example, each pixel unit includes a red sub-pixel, a green sub-pixel and a blue sub-pixel, whereby the pixel unit, as a whole, can emit light of various colors, including white light, red light, green light, blue light, etc., and thus one or more pixel units can be lit to provide corresponding illumination light (e.g., the red light) according to different types of illumination light (e.g., the red light) for implementing the texture image detection, required by the optical sensing device 300. For another example, in this embodiment, the detection of the ambient light performed by the optical sensing device 300 is based on the light (e.g., the green light) different from the illumination light which is used for implementing texture detection, and thus the illumination light emitted by the pixel unit is not detected as the ambient light during the texture image detection.

For example, an electronic device panel 10 having a fingerprint identification function is taken as an example, as illustrated in FIG. 5B, and the electronic device panel 10 includes a touch layer 101 and a protective cover plate 102, and also includes a controller 500, a light source array 600, an imaging array 301, and a photoelectric sensor 302. For example, the electronic device panel 10 can be used for fingerprint detection and thus can be further used for fingerprint identification.

It can be seen from FIG. 5B that the imaging array 301 and the photoelectric sensor 302 are on different substrates, and these different substrates are stacked one on another, which can be referred to the detailed description above with respect to FIG. 3C. In addition, the light source array 600 of the electronic device panel 10 includes a plurality of light source units 601 that are arranged in an array within a predetermined region. The plurality of light source units 601 are on a side of the photoelectric sensor 302. The imaging array 301 includes a plurality of imaging array units 303, and the plurality of imaging array units 303 are configured to receive light that is emitted from the plurality of light source units 601 and reflected to the imaging array units 303 via textures, so as to implement texture acquisition.

In the above embodiments, the imaging array 301 is on a side which is opposite to the light source array 600. For example, in some other embodiments, the imaging array 301 may be on the same layer as the light source array 600. For example, the plurality of imaging array units 303 included in the imaging array 301 are spaced apart from the light source units 601 on the same layer. For example, the imaging array 301 and the light source array 600 may be formed on a same array substrate together by a semiconductor process.

It should be noted that the embodiments of the present disclosure do not specifically limit the arrangements of the imaging array 301 and the light source array 600, as long as the imaging array units 303 can receive the light that is emitted from the light source units 601 and reflected to the imaging array units 303 via textures for texture acquisition.

In combination with the functions of the controller 500 described above, the electronic device panel 10 illustrated in FIG. 5B provides a new wake-up scheme for fingerprint identification, which can also detect the brightness of the screen in real time, so as to prevent the brightness of the screen from being too high, thereby prolonging the service life of the screen.

At least one embodiment of the present disclosure also provides a photoelectric processing unit 200. The photoelectric processing unit 200 includes an optical sensing device 300 and a signal processing device 400. The optical sensing device 300 is in a photoelectric sensing region 100 of an electronic device in the case where the photoelectric processing unit 200 is provided in the electronic device, and is configured to sense the photoelectric sensing region 100, so as to obtain a texture image data signal, and sense ambient light in the photoelectric sensing region 100, so as to obtain an ambient light detection electrical signal. The signal processing device 400 is configured to process the texture image data signal and the ambient light detection electrical signal.

For example, in some embodiments, the optical sensing device 300 and the signal processing device 400 are on a same circuit board (e.g., a flexible printed circuit board) and electrically connected to each other.

At least one embodiment of the present disclosure also provides an electronic device, which includes any electronic device panel 10 described above or any photoelectric processing unit 200 described above.

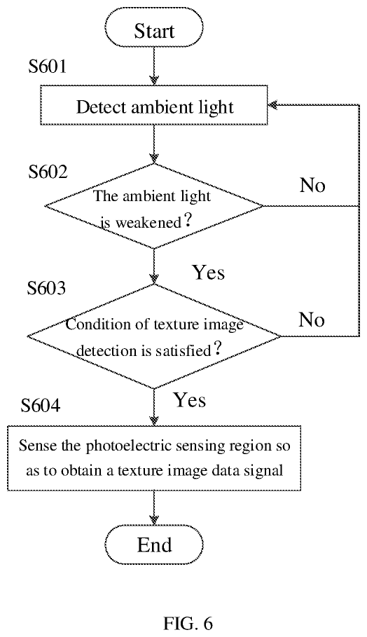

FIG. 6 is a flowchart of a processing method for an electronic device provided by some embodiments of the disclosure.

For example, in some embodiments, the electronic device includes a photoelectric sensing region, and as illustrated in FIG. 6, the processing method for the electronic device includes following operations:

step S601, detecting ambient light in the photoelectric sensing region, so as to obtain an ambient light detection electrical signal;

step S602, determining whether the ambient light is weakened according to a processing result of the ambient light detection electrical signal, and in the case where the ambient light is weakened, executing step S603, otherwise, returning to step S601;

step S603, determining whether a condition of texture image detection is satisfied, and in the case where the condition of the texture image detection is satisfied, executing step S604, otherwise, returning to step S601; and

step S604, sensing the photoelectric sensing region to obtain a texture image data signal.

For example, in step S601, a photoelectric sensing device that is used for sensing the ambient light, such as a photoelectric sensor, senses the ambient light in the photoelectric sensing region and generates a corresponding detection electrical signal. A controller receives the detection electrical signal and controls other components to perform corresponding operations according to the enhancement or weakness of the ambient light. For example, in the case where the ambient light is enhanced, the controller can control a light emitting array to automatically increase the luminous intensity of the light emitting array. In step S602, according to the processing result of the ambient light detection electrical signal, determining whether the ambient light is weakened may include determining whether the amount of the variation of the ambient light is within a predetermined range. For example, in the case where the amount of reduction in the brightness of the ambient light exceeds a predetermined value, the controller may determine that the ambient light is weakened. In the case where the ambient light is not weakened, the process returns to step S601, so as to continue detecting the ambient light. In the case where the ambient light is determined to be weakened, it is further determined whether the condition of texture image detection is satisfied, for example, the sudden change of the ambient light, the detection of an operator (e.g., a finger or a palm) having textures touching the photoelectric sensing region, etc., that is, step S603 is executed. In the case where the condition of the texture image detection is not satisfied, the process returns to step S601, so as to continue detecting the ambient light, and in the case where it is determined that the condition of the texture image detection is satisfied, step S604 is executed, and the controller controls to perform the texture image detection.

Therefore, the processing method for the electronic device provided by the above embodiments of the present disclosure provides a wake-up method for texture image detection. The combination of the ambient light detection function and the texture wake-up function effectively avoids the false triggering problem which is easily caused by the existing wake-up methods, such as touch induction, gravity induction, etc.

For example, in some embodiments, the condition of the texture image detection includes that the ambient light reduces by an amount of light of a predetermined range during a predetermined time. For example, in the case where a finger or a palm of an operator stays in the photoelectric sensing region, the light rays of the ambient light which is irradiated in the photoelectric sensing region are reduced in a short time. For another example, in some other embodiments, the condition of the texture image detection may further include that a touch sensor senses that an operator touches the photoelectric sensing region. For still another example, in some embodiments, the condition of the texture image detection may further include that a proximity sensor senses that an operator is approaching the photoelectric sensing region.

It should be noted that the embodiments of the present disclosure include, but are not limited to the condition of the texture image detection described above. The condition of the texture image detection may be any combination of different image detection conditions, and the embodiments of the present disclosure are not limited thereto.

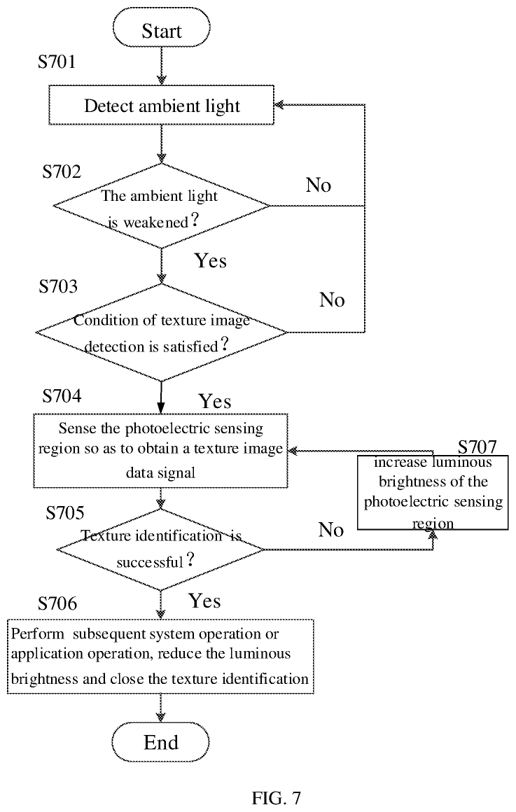

FIG. 7 is an exemplary flowchart of a processing method for an electronic device, which is applied to texture identification, provided by some embodiments of the present disclosure.

For example, in some embodiments, the processing method illustrated in FIG. 7 includes:

step S701, detecting ambient light in the photoelectric sensing region, so as to obtain an ambient light detection electrical signal;

step S702, determining whether the ambient light is weakened according to a processing result of the ambient light detection electrical signal, and in the case where the ambient light is weakened, executing step S703, otherwise, returning to step S701;

step S703, determining whether a condition of texture image detection is satisfied, and in the case where the condition of the texture image detection is satisfied, executing step S704, otherwise, returning to step S701;

step S704, sensing the photoelectric sensing region to obtain a texture image data signal;

step S705, performing a texture identification operation based on the texture image data signal that is obtained, and in the case where the texture identification operation is successful, continuing executing step S706, otherwise, executing step S707;

step S706, performing a system operation or an application operation that is performed subsequently, and closing an operation that is used for texture identification; and

step S707, increasing luminous brightness of a light source array in the photoelectric sensing region, and returning to step S704 to sense the photoelectric sensing region again and perform the texture identification operation again.

After step S704 is executed again, step S705 is executed. In the case where the texture identification operation is successful this time, step S706 is executed to reduce the luminous brightness of the light source array in the photoelectric sensing region and close the operation that is used for texture identification.

Because steps S701-S704 are similar to steps S601-S604 in FIG. 6, the detailed description of steps S701-S704 may be referred to the above description of steps S601-S604 in FIG. 6, which may not be repeated here.

For example, in step S705, determining whether the texture identification operation is successful refers to determining whether the sensed texture image data satisfies a predetermined requirement. The predetermined requirement may include whether the sensed texture image data is consistent with pre-recorded or pre-stored data. If consistent, the texture identification is successful, then a system operation or an application operation that is performed subsequently is executed, that is, step S706 is executed. For example, a mobile phone displays a main interface or opens an application program after the fingerprint identification is successful, an entrance guard system is turned on to allow users to pass through after the fingerprint identification is successful, and an automobile starting device having a fingerprint identification function starts after the fingerprint identification is successful, etc., and the embodiments of the present disclosure are not limited thereto.

If not consistent, the texture identification operation fails. In this case, the reason causing the failure of the texture identification operation may be that the texture of the current operator is different from the pre-recorded and pre-stored textures, or the brightness of the illumination light is not sufficient, so that the texture image data cannot be clearly detected. Therefore, after the texture identification operation fails, step S707 is executed to increase the luminous brightness of the light source array in the photoelectric sensing region, so that the luminous brightness reaches the brightness required for the texture identification operation, then the photoelectric sensing region is sensed again and the texture identification operation is performed again, so that the success rate of the texture identification operation can be improved. In the case where the texture identification operation is successful this time, the luminous brightness of the light source array in the photoelectric sensing region is reduced, and the operation that is used for texture identification is closed. In this way, the luminous brightness of the light source array can be automatically adjusted and the operation that is used for texture identification can be automatically closed, thereby saving the power consumption of the electronic device and prolonging the working time of the battery. In addition, in the whole process of the processing method, the brightness of the screen is detected in real time, so as to prevent the brightness of the screen from being too high.

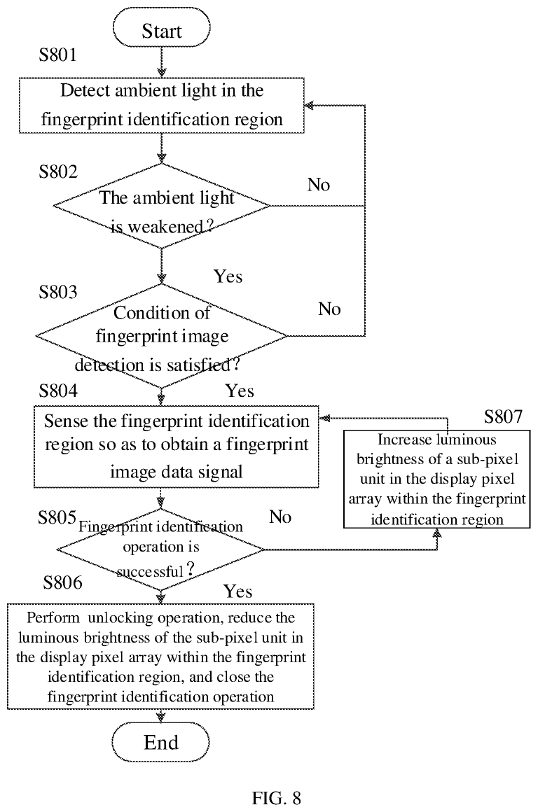

FIG. 8 is an exemplary flowchart of a processing method for an electronic device that includes a display panel, which is applied to fingerprint identification for unlocking, provided by some embodiments of the present disclosure. For example, the display panel is the exemplary display panel illustrated in FIG. 1B, and the display panel includes a display region which includes a fingerprint identification region. A display pixel array of the display region includes a plurality of display pixel units, and each display pixel unit includes a display sub-pixel unit. The display pixel array may function as a light source array, and the display pixel unit or the display sub-pixel unit may function as a light source unit. Therefore, the display pixel array in the fingerprint identification region is also at least partially used as a light source of the illumination light for fingerprint image detection.

As illustrated in FIG. 8, in some embodiments, the processing method for the electronic device that includes the display panel includes:

step S801, detecting ambient light in the fingerprint identification region;

step S802, determining whether the ambient light is weakened according to a processing result of the ambient light detection electrical signal, and in the case where the ambient light is weakened, executing step S803, otherwise, returning to step S801;

step S803, determining whether a condition of a fingerprint image detection is satisfied, and in the case where the condition of the fingerprint image detection is satisfied, executing step S804, otherwise, returning to step S801;

step S804, sensing the fingerprint identification region to obtain a fingerprint image data signal;

step S805, performing a fingerprint identification operation based on the fingerprint image data signal that is obtained, and in the case where the fingerprint identification operation is successful, continuing executing step S806, otherwise, executing step S807;

step S806, performing an unlocking operation, and closing an operation that is used for fingerprint identification; and

step S807, increasing luminous brightness of sub-pixel units, that are used for emitting illumination light for fingerprint detection, in the display pixel array within the fingerprint identification region, and then executing step S804.

After step S804 is executed again, step S805 is executed. In the case where the fingerprint identification operation is successful this time, the luminous brightness of the sub-pixel units, that are used for emitting the illumination light for fingerprint detection, in the display pixel array within the fingerprint identification region is reduced, and the operation that is used for fingerprint identification is closed. Therefore, the embodiments of the present disclosure provide a new technical scheme for waking up fingerprint unlocking of the display panel, which can be applied to various electronic devices having a display function, such as a smart phone, a tablet computer, a smart watch, a smart door lock, etc., and can correspondingly adjust the luminous brightness of the display pixel array in the display region in response to the variation of the ambient light. In this way, the processing method for the electronic device effectively improves the user's experience and saves the power consumption of the electronic device.

For the present disclosure, the following statements should be noted.

(1) The accompanying drawings involve only the structure(s) in connection with the embodiment(s) of the present disclosure, and other structure(s) can be referred to common design(s).

(2) For clarity, in the drawings for describing the embodiments of the present disclosure, the thickness of a layer or a region can be enlarged or reduced, i.e., the drawings are not drawn to actual scale. It should be understood that in the case where an element such as a layer, a film, a region or a substrate is referred to as being “on” or “under” another element, the element may be “directly” “on” or “under” the other element or an intervening element may be present.

(3) In case of no conflict, the embodiments of the present disclosure and features in the embodiments may be combined with each other to obtain new embodiments.

What are described above are related to the specific implementations of the present disclosure only and not limitative to the scope of the disclosure, and the scope of the disclosure is defined by the accompanying claims.

What is claimed is:

1. An electronic device panel, comprising a photoelectric sensing region and a photoelectric processing unit, wherein the photoelectric processing unit comprises:
an optical sensing device in the photoelectric sensing region, configured to sense the photoelectric sensing region, so as to obtain a texture image data signal, and sense ambient light in the photoelectric sensing region, so as to obtain an ambient light detection electrical signal; and
a signal processing device, configured to process the texture image data signal and the ambient light detection electrical signal.

2. The electronic device panel according to claim 1, wherein the optical sensing device comprises an imaging array and a photoelectric sensor,
the imaging array is configured to sense the photoelectric sensing region to obtain the texture image data signal, and
the photoelectric sensor is configured to sense the ambient light in the photoelectric sensing region to obtain the ambient light detection electrical signal.

3. The electronic device panel according to claim 2, wherein the imaging array and the photoelectric sensor are on a same substrate, the imaging array comprises a plurality of imaging array units, and
the photoelectric sensor is between adjacent imaging array units within the imaging array or at an edge of the imaging array.

4. The electronic device panel according to claim 2, wherein the imaging array and the photoelectric sensor are on different substrates, and the different substrates are stacked one on another.

5. The electronic device panel according to claim 1, wherein the photoelectric sensing region is a fingerprint identification region, the texture image data signal is a fingerprint image data signal, and
the optical sensing device is configured to sense the photoelectric sensing region to obtain the fingerprint image data signal.

6. The electronic device panel according to claim 1, wherein the signal processing device comprises a first processing circuit that is used for the texture image data signal and a second processing circuit that is used for the ambient light detection electrical signal, and the first processing circuit and the second processing circuit are integrated on a same circuit board or integrated in a same chip.

7. The electronic device panel according to claim 1, wherein the optical sensing device and the signal processing device are on a same circuit board, and the optical sensing device is electrically connected to the signal processing device.

8. The electronic device panel according to claim 1, further comprising a controller, wherein the controller is configured to:
control the optical sensing device to detect the ambient light in the photoelectric sensing region;
determine whether the ambient light is weakened according to a processing result of the ambient light detection electrical signal obtained by the signal processing device;
determine whether a condition of texture image detection is satisfied in a case where the ambient light is weakened; and
control the optical sensing device to perform the texture image detection on the photoelectric sensing region in a case where the condition of the texture image detection is satisfied.

9. The electronic device panel according to claim 1, further comprising a light source array, wherein the light source array comprises a plurality of light source units, and
the plurality of light source units are at least partially within the photoelectric sensing region and are configured to emit light according to a light emission signal, so as to provide illumination light for texture image detection.

10. The electronic device panel according to claim 9, further comprising a controller, wherein the controller is configured to:
increase luminous brightness of the light source array in the photoelectric sensing region in response to a processing result of the photoelectric processing unit.

11. The electronic device panel according to claim 10, wherein the controller is further configured to:
light at least part of the light source units in the photoelectric sensing region or light a sub-array that is formed by at least part of the light source units, so as to provide the illumination light for the texture image detection.

12. The electronic device panel according to claim 9, wherein the electronic device panel is a display panel that comprises a display region, the display region comprises a display pixel array, the display pixel array comprises a plurality of display pixel units, and each of the display pixel units comprises a display sub-pixel unit, and
the light source array comprises at least part of the display pixel array, each of the plurality of light source units comprises one or more display pixel units or one or more display sub-pixel units, and the photoelectric sensing region is within the display region.

13. A photoelectric processing unit, comprising:
an optical sensing device in a photoelectric sensing region, configured to sense the photoelectric sensing region, so as to obtain a texture image data signal, and sense ambient light in the photoelectric sensing region, so as to obtain an ambient light detection electrical signal; and
a signal processing device, configured to process the texture image data signal and the ambient light detection electrical signal.

14. The photoelectric processing unit according to claim 13, wherein the optical sensing device and the signal processing device are on a same circuit board, and the optical sensing device is electrically connected to the signal processing device.

15. A processing method for an electronic device, wherein the electronic device comprises a photoelectric sensing region, and the processing method comprises:
detecting ambient light in the photoelectric sensing region, so as to obtain an ambient light detection electrical signal;
determining whether the ambient light is weakened according to a processing result of the ambient light detection electrical signal;
determining whether a condition of texture image detection is satisfied in a case where the ambient light is weakened; and
sensing the photoelectric sensing region to obtain a texture image data signal in a case where the condition of the texture image detection is satisfied.

16. The processing method according to claim 15, wherein the condition of the texture image detection comprises:
the ambient light reducing by an amount of light of a predetermined range during a predetermined time.

17. The processing method according to claim 15, further comprising:
processing the texture image data signal to perform a texture identification operation, and performing a system operation or an application operation that is performed subsequently in a case where the texture identification operation is successful.

18. The processing method according to claim 17, further comprising:
increasing luminous brightness of a light source array in the photoelectric sensing region, sensing the photoelectric sensing region again, and performing the texture identification operation again, in a case where the texture identification operation fails.

19. The processing method according to claim 17, further comprising:
reducing luminous brightness of a light source array in the photoelectric sensing region, and closing an operation that is used for texture identification, after the texture identification operation is successful.
